(19) United States
(12) Patent Application Publication
(10) Pub. No.: US 2013/0339188 A1
(43) Pub. Date: Dec. 19, 2013

(54) GIFT TOKEN

(71) Applicants: Riaz Ebrahim Mohamed, Tamilnadu (IN); Kavuri Tulasi Ram, Tamilnadu (IN)

(72) Inventors: Riaz Ebrahim Mohamed, Tamilnadu (IN); Kavuri Tulasi Ram, Tamilnadu (IN)

(73) Assignee: eBay Inc., San Jose, CA (US)

(21) Appl. No.: 13/525,674

(22) Filed: Jun. 18, 2012

(51) Int. Cl. G06Q 30/06

(52) U.S. Cl. 705/26.41

(57) ABSTRACT

Systems and methods are disclosed for giving gifts in the form of secure tokens. A gift can be given from a user of a payment provider to a gift recipient. The recipient can be a member of the user's family, a friend, or any other person or entity. The recipient can use the token to purchase a product using a checkout though the payment provider. The purchase can be made without requiring the user to create the user's own payment provider account.

### BACKGROUND

1. Technical Field

The present disclosure generally relates to electronic commerce and, more particularly, relates to a system and method for sending gifts electronically via a token.

2. Related Art

The use of security tokens in electronic commerce is known. Such a token can be used to authenticate a customer and to facilitate payment for a purchase. A customer possessing a token can be assumed to be authorized to make a purchase using a payment provider account for which the token was issued. After the purchase, money can be transferred from the payment provider account to an account of the merchant. During a purchase transaction, the customer can present the token to the merchant. The token can be presented either along with or in place of a password.

Both software and hardware tokens can be used to make purchases. Software tokens are typically stored in an electronic device, such as a computer or cellular telephone. Hardware tokens can be embodied in a hardware device, such as a USB device or a smart card.

Hardware tokens that physically or wirelessly connect to a reader can be referred to as connected tokens. Connected tokens are read by the reader at the point of sale (POS) and the reader is in communication with a server to facilitate authentication of the customer.

Hardware tokens that do not physically or wirelessly connect to a reader can be referred to as disconnected tokens. Disconnected tokens do not use a reader. Instead, disconnected tokens have a display that shows authentication information, such as a numeric code. The authentication information can be entered into an input device, such as a keypad at the POS, by the customer. The authentication info nation can function in a manner similar to a personal identification number (PIN).

### SUMMARY

Systems and method are disclosed for giving gifts or payment instruments in the form of security or payment tokens, according to an embodiment. A gift or payment instrument can be given from a user of a payment provider, such as Paypal, Inc., to a gift recipient. The recipient can be a member of the user's family, a friend, a sub-contractor, or any other person or entity. The recipient can use the token to purchase a product using the payment provider. The purchase can be made from a brick and mortar store or an online store. The purchase can be made without requiring the user to create the user's own payment provider account.

According to an embodiment, a system can comprise a memory and one or more processors, such as a memory and processor(s) of the payment provider. The memory can store account information in an account of the user. The processor(s) can receive a communication including a request that a token for a specified money amount be issued by the payment provider. The processor(s) can access the account of the user, determine from the account if the user is authorized to have the token issue for the specified money amount, generate the token if the user is authorized to have the token issue for the specified money amount, and send information regarding the token to the user and/or the recipient.

According to an embodiment, the token can be issued to a specified recipient and the specified recipient does not have an account with the payment provider. Thus, a person who does not have an account with the payment provider can use the token and thereby become familiar with making purchases via the payment provider. This familiarity may entice the recipient to obtain an account with the payment provider.

The token can include information representative of an identification of the recipient. The token can include information representative of an amount or a maximum amount of money that can be spent by the recipient of the token. The token can include information representative of various other limitations. For example, the token can be limited to use at a specified store, a specified group of stores, or a specified chain of stores. The token can be limited to use in purchasing a specified product. The token can be limited to use geographically. For example, the token can be limited to use within a specified city or group of cities, within a specified state or group of states, within a specified country or group of countries, and/or at any location or group of locations. The token can be limited to use temporally. For example, the token can be limited to use on weekdays, on weekends, from 11:00 AM to 1:00 PM on weekdays, and/or at any other time.

According to an embodiment, a system can comprise a memory, such as a memory of a payment provider, which stores account information of a user in a user account. The account information can include a name of a recipient of a token, such as a gift token, and a money amount for the token. The token can have been given by the user to the recipient. The recipient is not required to have to have an account with the payment provider.

One or more processors can be operable to receive a communication including a request that the token be used by a person to make a purchase for a specified money amount, access the user account, determine from the user account if person is the recipient and if the specified money amount is less than or equal to the money amount of the token, and authorize the purchase if the person is the recipient and if the specified money amount is less than or equal to the money amount of the token.

According to an embodiment, the processor(s) are operable to create an account, e.g., a payment provider account, for the recipient without requiring the recipient to participant in creation of the account. For example, the processor(s) can request permission from the recipient to create an account for the recipient and, if such permission is granted, create an account for the recipient without requiring further participation from the recipient. Thus, the recipient does not have to supply further information to the payment provider in order to create the account. For example, the recipient is not required to fill out an application form. The processor(s) can create an account for the recipient using information regarding the recipient that was obtained from one or more purchase transactions made by the recipient using the token when such information is deemed to be sufficient to the payment provider for the opening of a new account. The processor(s) can alternatively or additionally use publicly available or other information that is accessible to the payment provider. The processor(s) can query the user for additional information.

The information obtained from the one or more purchase transactions made by the recipient using the token can include the recipient's home address, employer, business address, home telephone number, work telephone number, cellular telephone number, driver's license number, social security number, and/or one or more credit card numbers. The information can be any information that is useful for creating the payment provider account.

According to an embodiment, the processor(s) can receive a communication from the recipient including a mobile number of the recipient to facilitate authorization of the purchase. For example, the account information can include a mobile number of the recipient and the processor(s) can receive a communication that includes a number entered by the recipient via a merchant device, compare the communicated number to the mobile number, and authorize the purchase if the communicated number is the same as the mobile number. Thus, the mobile number can function as a PIN, for example.

According to an embodiment, the processor(s) can receive a communication including a request that the token be issued for a specified money amount, access the user account, determine from the user account if the user is authorized to have the token issue for the specified money amount, generate the token if the user is authorized to have the token issue for the specified money amount, and send information regarding the token to the user.

The token can be a hardware token and the information regarding the token can include instructions for obtaining the hardware token. The token can be a software token and the information regarding the token can include the software token itself. The information regarding the token can confirm the identity of the intended recipient of the token. The information regarding the token can also confirm the money amount of the token and any limitations regarding the use of the token.

The token can a gift token. The token does not have to be a gift. For example, the token can be paid for by the recipient. Payment for the token can be made to the user, to the payment provider, or to any other person or entity. As a further example, the token can be a payment made by the user to the recipient, such as for goods received or services rendered. Generally, the token may be described as a payment token that allows the recipient to use the token to make a payment using the services of the payment provider issuing the token on behalf of the user.

### BRIEF DESCRIPTION OF THE DRAWINGS

FIG. 1 is a block diagram of a system for providing gift tokens, according to an embodiment;

FIG. 2 is a flow chart showing a method for providing gift tokens, according to an embodiment;

FIG. 3 is a flow chart showing further detail of the method for providing gift tokens, according to an embodiment; and

FIG. 4 is a block diagram of an example of a computer that is suitable for use in the system for real-time advertisement and negotiation, according to an embodiment.

### DETAILED DESCRIPTION

Systems and methods are disclosed for giving a gift in the form of a security token, according to an embodiment. The gift can be given from a user of a payment provider, such as Paypal, Inc., to a gift recipient. The recipient can be a member of the user's family, a friend of the user, or any other person or entity. For example, the recipient can be a business, charity, or club.

The recipient can use the token to purchase a product using a checkout though the payment provider. The purchase can be made without requiring the user to create the user's own payment provider account. Many people are initially reluctant to create their own payment provider account. They may be intimidated by the sign up process, use of the payment provider system, or computers generally, and/or they may be hesitant to provide sensitive personal information required to create an account. However, even people who are reluctant to create their own payment provider account are likely to be willing to use a gift token. Because of its ease of use, the use of the gift token may entice such people to create their own payment provider account.

In this manner, the recipient, various merchants, and the payment provider can achieve a lasting benefit beyond the benefit associated directly with the recipient's immediate use of the token. That is, the use of gift tokens is likely to cause the number of payment provider users to grow. Such growth of the number of payment provider users increases the business and potential for profit for the payment provider, as well as for the merchants associated with the payment provider.

The token can be given without the user sharing the user's credential with the recipient. Thus, the recipient cannot potentially compromise the user's information, credit, or any other aspect of the user's payment provider account. The recipient is not required to have a payment provider account and is not required to have any association with the user or the user's account. A malicious recipient does not have any access to the user's account or account information. In this manner, any risk to the user can be limited to the amount of the gift token.

Although the recipient does not have to have or create a payment provider account, the user can have or can create a payment provider account. Whether the recipient has a payment provider account or does not have a payment provider account has no impact upon the recipient's ability to use the token.

The token can be a software token or a hardware token. The token can be a connected token or a disconnected token. The token can be any kind of security token that can be used by the recipient to a purchase a product.

The token can be used to purchase a product from a brick and mortar store. The token can be used to purchase a product from an online store. The token can be used to purchase a product from any person, store, or other entity that will accept the token. Generally, the token can be used to purchase a product from any store that accepts payment via the payment provider.

The token can include information representative of an identification of the recipient. For example, the token can include a name, address, description, birth date, picture, account number, driver's license number, or any other identification of the recipient.

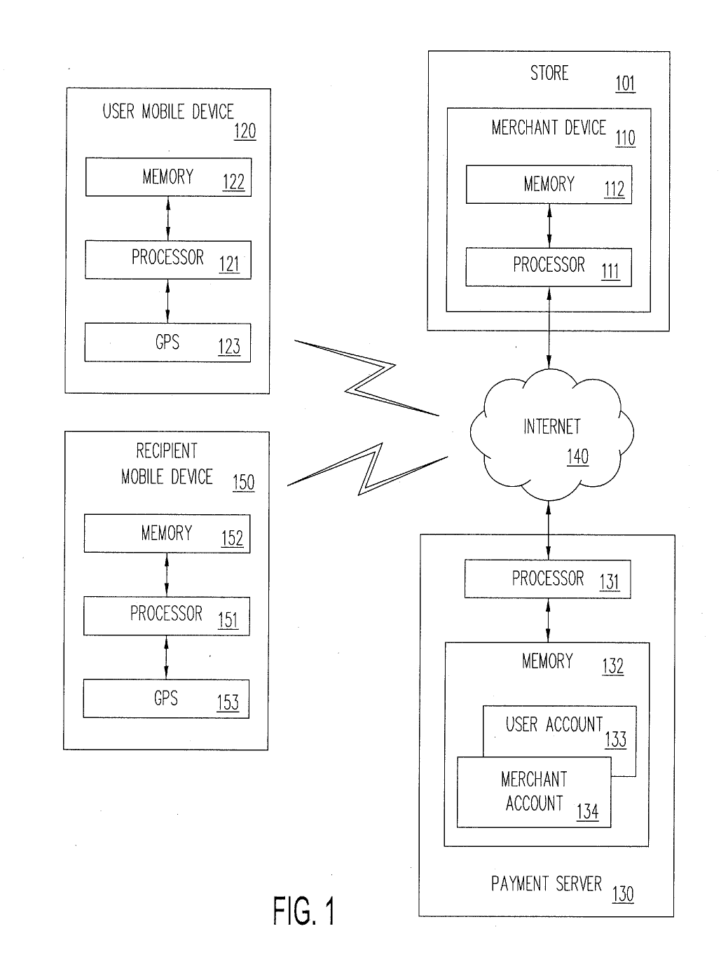

FIG. 1 is a block diagram showing a gift token system, according to an embodiment. The system can include a store 101 having a merchant device 110 to handle purchase transactions between the store 101 and consumers or users. The store 101 can be a brick and mortar store, an online store, or any other type of store. The merchant device 110 can be merchant checkout or point of sale system, a computer, a server, a computing tablet, a mobile device, or any other device suitable for facilitating checkout via the payment provider. The merchant device 110 can have a processor 111 and a memory 112. The processor 110 can execute a software program stored in the memory 112 for facilitating purchase transactions using tokens via the payment provider.

The payment provider can have a payment server 130 that can facilitate payment from the user to the merchant for the product purchased, wherein the term “product” as used herein may refer to physical products, digital goods, services, or anything for which a user can make a payment, including charitable donations. The payment server 130 can have a processor 131 in communication with a memory 132. The processor 131 can be one or more processors. The processor 131 can access a user account 133 and a merchant account 134 stored in the memory 132.

The merchant device 110 can communicate with the payment server 130, such as via a network. For example, the merchant device 110 can communicate with the payment server 130 via the Internet 140. The merchant device 110 can communicate with a plurality of different the payment servers 130. The plurality of different payment servers 130 can communicate among themselves and can be considered herein as being the same as a single payment server 130.

The user can have a user mobile device 120 to interact with a recipient of a payment token, the payment provider, and/or one or more merchants to create and send the payment token. The user mobile device 120 can be a cellular telephone, a tablet computer, a laptop computer, or the like. The user mobile device 120 can have a processor 121, a memory 122, and a global positioning system (GPS) 123. The processor 121 can execute an app that facilitates the gift token method discussed herein. The app can be stored in the memory 122. The app can provide a graphical user interface (GUI) for the user to use when requesting the token, for example.

Similarly, the recipient can have a recipient mobile device 150 to interact with a user, payment provider, and/or one or more merchants to receive and/or use a payment token. The recipient mobile device 150 can be a cellular telephone, a tablet computer, a laptop computer, or the like. The recipient mobile device 150 can have a processor 151, a memory 152, and a global positioning system (GPS) 153. The processor 151 can execute an app that facilitates the gift token method discussed herein. The app can be stored in the memory 152. For example, the gift token can be a software token and the app can be use to receive the gift token and to use the gift token to make a purchase. The app can provide a GUI for the recipient to use when purchasing a product with the token.

Alternatively, the recipient mobile device 150 can lack such an app. For example, the gift token can be a hardware token that is used independently with respect to any recipient device, such as the recipient mobile device 150.

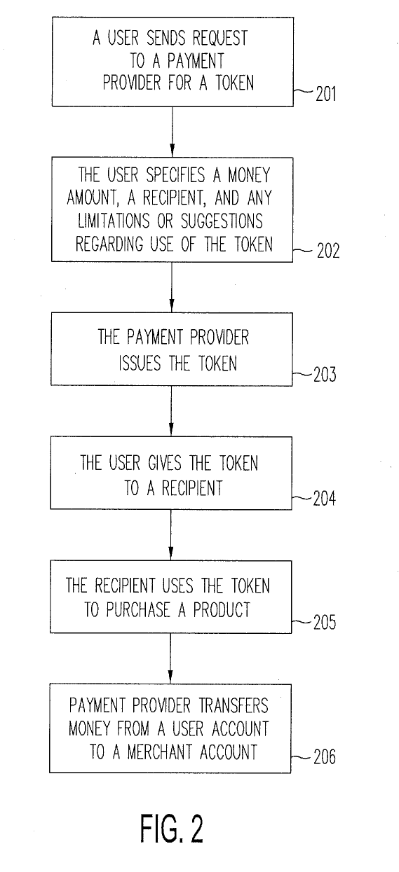

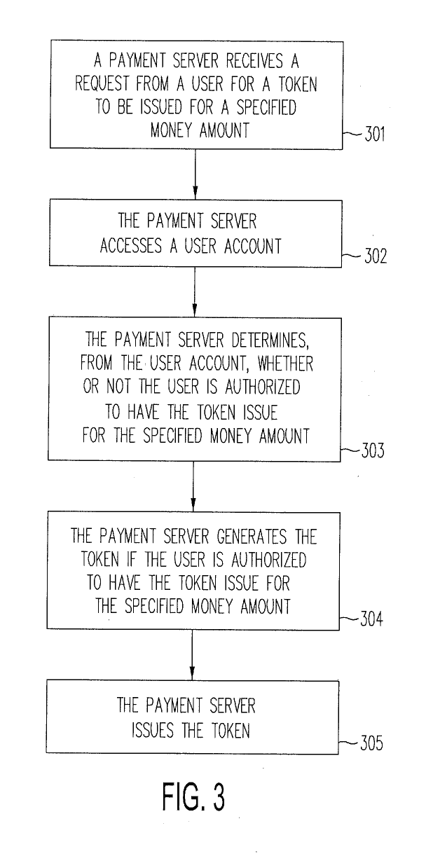

FIGS. 2 and 3 are flow charts that describe examples of operation of the gift token system according to embodiments thereof. Note that one or more the steps described herein may be combined, omitted, or performed in a different order as desired or appropriate.

FIG. 2 is a flow chart showing a method for providing gift tokens, according to an embodiment. The user can send a request to a payment provider for a token, as shown in step 201. For example, the user can send the request from the mobile device 120 to the payment server 130 via the Internet 140. The request can be sent via a cellular telephone, desktop computer, or any other device suitable for sending the request.

The user can specify a money amount, a recipient, and any desired limitations or suggestions regarding the token, as shown in step 202. Such limitations can include limitations regarding the store(s) where the token can be used, the product(s) that can be purchased with the token, an expiration time/date for the token, the geographic area(s) where the token can be used, and/or the time(s) at which the token can be used. For example, the token can be limited to use at a specified store, a specified group of stores, or a specified chain of stores. The token can be limited to use for purchasing a specified product or type of product. The token can be limited to use geographically. For example, the token can be limited to use within a specified city or group of cities, within a specified state or group of states, within a specified country or group of countries, and/or at any location or group of locations. Use of the token can be limited to use temporarily. For example, the token can be limited to use on weekdays, on weekends, from 11:00 AM to 1:00 on weekdays, and/or at any other time.

The token can be specified for use by a one or more people, one or more entities, or any combination thereof. For example, the token can be specified for use by a person named John Doe, as well as specified employees of John Doe's business. As a further example, the token can be specified for use by any of the employees of International Business Machines Corporation (IBM).

The token can expire after a specified amount of time. For example, the token can expire after one day, five days, one week, three weeks, or one month from the date of issuance.

The token can have a different value depending on any specified criteria. For example, the token can decline in value from the date of issuance until a specified date in the future. The token can have one value if used at a specified store and another value if used at any other store. The token can have one value if used to purchase a specified product and another value if used to purchase any other product.

A limit can be placed on how quickly the token can be spent. For example, the token can be limited to purchases totaling $50 per day, purchases totaling $600 per week, or purchases totaling $2,000 per month.

Products can be specified for which the token cannot be used to purchase. For example, a limitation upon the use of the token can specify that the token cannot be used for the purchase of alcohol or cigarettes. Rather than not allowing such items altogether, a limit can be placed on the amount of such purchases in a given time period. For example, $20 worth of beer and $10 worth of cigarettes can be purchased in one week.

Contingent limitations can be provided. For example, the recipient can be permitted to purchase $10 worth of cigarettes each week only if no alcohol has been purchased. As a further example, the recipient can be permitted to purchase alcohol only on weekends. Specified purchases or types of purchase can require permission. These purchases can require permission from the user or from someone specified by the user. For example, purchases of alcohol and cigarettes can require that the recipient contact the user, such as via cellular telephone, email, or text messaging, and request authorization to make the purchase. The user can then use the app to authorize the purchase, if desired. The app can, for example, communicate the authorization to the payment server and the payment server 131 can communicate the authorization to the recipient mobile device 150 or the merchant device 110 at the store 101 where the purchase is desired.

The gift token system can check the age of the recipient. If the recipient is under the legal age for purchasing particular items, then the gift token system can automatically limit use of the token such that the particular items cannot be purchased with the token. The gift token system can check the age of the recipient by accessing a database where this information is stored or by querying the user. The user can specify the birth dates of potential token recipients during a setup procedure of the gift token system.

On a birthday, holiday, or other event, or at a predetermined time before the event, the gift token system can remind the user of the upcoming event and can query the user to see if the user would like to have a gift token issued due to the event. For example, two weeks before the user's wife's birthday, the gift token system can send a text message, email, or other communication to the user to see if the user would like to have a gift token issued to the user's wife.

Any combination of limits can be specified for the token. The limits can be changed after the token is issued. According to an embodiment, changing the limits can only be done by the user or by a person specified by the user. For example, the user can specify that the user's wife can change limits for tokens given to the user's children.

According to an embodiment, the user can specify another person to issue tokens on behalf of the user. For example, a user can specify the user's husband to have tokens issued on behalf of the user. The other person can have all of the authority to issue tokens as the user. The other person can have limited authority to issue tokens. For example, the other person can be given authority to issue tokens up to a predetermined money amount. The authority of the other person to issue tokens on behalf of the user can last indefinitely, e.g., until revoked. The authority of the other person to issue tokens on behalf of the user can last for a specified amount of time.

According to an embodiment, the user can specify a machine to issue tokens on behalf of the user. For example, the gift token system can be set up to have the payment server 130 automatically issue a token for a specified money amount to each specified recipient periodically, e.g. daily, weekly, monthly, or yearly. As a further example, the gift token system can be set up to have the payment server 130 automatically issue a token for a specified money amount to each specified recipient on or just before the recipient's birthday and Christmas. The token can be subject to any specified limitations.

Merchants can encourage the use of tokens by offering special deals or discounts for their use. For example, a music store can offer a 15% discount on all Gibson guitars purchase with a token over the Memorial Day weekend. As a further example, a chain store can offer a discount or rebate if the entire token is used with the chain. Thus, Walmart can provide a rebate if all of the token is used at Walmart stores. The notice of the potential availability of this rebate can be included in the information from the payment server that accompanies the token. The rebate can be in the form of a token. The rebate can be given to the user, the recipient, or any other person. The other person can be selected and specified by the store, the user, the recipient, or any further other person.

The rebate can be contingent upon the issuance of another token, such as for an amount greater than the rebate. The rebate can be contingent upon any other criteria. For example, in order to get a rebate of $20, the user can be required to issue another gift token to the same recipient for an amount of at least $200 where the token is limited to use at the same chain store.

Rebates can be provided to the user, the recipient, or any other person. For example, the user or the recipient can specify who the rebate is to be provided to. The rebate can be a token, a check, a coupon, or any other type of rebate.

The user can provide suggestions for the use of the token. Such suggestions will be included in a message to the recipient. The message can be included in the token, e.g., can be part of the token. The message can be communicated to the recipient via telephone, text messaging, email, or any other method. The message can announce that the recipient is receiving the token, provide the money amount of the token, and list any limitations or suggestions regarding the token. Generally, anything that can be a limit can be a suggestion and visa versa.

The limits or suggestions can change automatically in response to various criteria. The limits or suggestions can change automatically in response to a change the law. For example, a user specified limit affecting the recipient's ability to purchase alcohol or cigarettes with the token can change automatically due to a change in the legal age for purchasing alcohol or cigarettes when the change in the law goes into effect. The limits or suggestions can change automatically in response to a change the marketplace. For example, a suggestion regarding what to purchase or where to purchase can change automatically in response to the opening or closing of a store or in response to a change in the availability of a product. Such automatic changes in limits or suggestions can be effected by the payment server 130, which can monitor the criteria, such as via the Internet and/or via connection to the relevant databases.

The payment provider can issue the token, as shown in step 203. When the token is issued, the payment server 130 can send information regarding the token to the user and/or the recipient. The information can in particulars about the token, such as the money amount of the token, any limitation on use of the token, and any suggestions for use of the token. The information can include instructions for obtaining the token and for using the token.

The token can be issued to the user and the user can give the token to the recipient, as shown in step 204. Alternatively, the token can be issued directly to the recipient. A software token can be issued by sending the token over the Internet to the user or recipient, such as to the mobile device 150 of the recipient. A hardware token can be issued by sending instructions to the user or the recipient regarding how to obtain the hardware token to the user or the recipient. The instructions can be sent via text messaging, email, voice messaging, or any other method. The instructions can instruct the recipient to pick up the hardware token at a local merchant, for example.

The recipient can use the token to purchase a product, as shown in step 205. Such a purchase can be subject to any limitations placed upon the purchase by the user.

To use a software token to purchase a product, the software token or a code derived from the software token (such as a hash that is representative of the software token) can be communicated from the recipient mobile device 150 to the merchant device 110, such as via Bluetooth or WiFi. The software token or the code can then be communicated from the merchant device 110 to the payment server 130, such as via the Internet 140. The recipient can acknowledge and agree to the transaction via the app, which can be executed on the recipient mobile device 150.

For example, the recipient can start the app on the recipient mobile device 150 by touching an icon on a screen of the recipient mobile device 150, the app can communicate with the merchant device 110 (such as via Bluetooth or WiFi) and/or payment server 130 (such as via Bluetooth, WiFi and/or cellular telephone system) to obtain a total amount of money needed for payment for the purchase, and the recipient can okay this money amount using the app. Payment can then be facilitated automatically via the recipient mobile device 150 in cooperation with the merchant device 110 and/or the payment server 130. For example, the merchant device 110 can use the token or the code to obtain authorization from the payment server 130 for the transaction. The payment server 130 can verify, via the user account 133, that the gift token is legitimate and is intended for use by the person who is making the purchase.

In using the software token, all interactions between the recipient device 150 (which contains the software token) and the merchant device 110 can be automatic or invisible to the recipient. Thus, interaction with the merchant and use of the token can be substantially simplified. For example, the merchant device 110 can recognize that a software token is present on the recipient mobile device 150 via a wireless query. That is, the token can be automatically detected by the merchant device 110. Then the recipient can be asked, such as verbally by the merchant, via text on the mobile device, via the app on the mobile device, or via any other method, if the recipient wants to use the token for the purchase. The use of such a software token can eliminate any need for the recipient to obtain and carry another item, such as a hardware token, gift card, etc.

To use a hardware token, the merchant can ring or total the purchase transaction. Then, to provide payment, the recipient can enter the code, such as a number, from the hardware token. The code can be entered manually by the recipient into a keypad of the merchant. Alternatively, the code can be entered automatically, such as via a camera, or sensor that reads the display of the hardware token. The merchant device 110 can use the code to obtain authorization from the payment server 130 for the transaction. The hardware token can display the available money balance before and after the purchase.

When using either a software token or a hardware token, the payment server 130 can thus receive a token or code from the merchant device 110. The token or code can be used to verify that the recipient is an authorized recipient and is entitled to make the purchase. The payment server 130 can thus authenticate the recipient and can communicate this authentication to the merchant device 110 so that the purchase transaction can be completed.

The recipient can use or ignore any suggestions provided by the user. Optionally, a message can be sent to the user when the token is used to purchase a product. The message can be sent from the payment server 130 to the mobile device 120 of the user, for example.

The payment provider can transfer money from the user account 133 to the merchant account 134, as shown in step 206. Thus, to pay for the purchase by the recipient, the payment server 130 can transfer the amount of money required for the purchase from the user account 133 to the merchant account 134. The user account 133 and the merchant account 134 can both be with the same payment provider, such that the payment server 130 can make the money transfer. If the user account 133 and the merchant account 134 are with different payment providers, then the payment server 130 of the user's payment provider can cooperate with a payment server of the merchant's payment provider to make the money transfer.

FIG. 3 is a flow chart showing further detail of the method for providing tokens, according to an embodiment. A payment server 130 can receive a request for a token to be issued for a specified money amount, as shown in step 301. The request can be from a user, for example. The request can be made via a computer or mobile device 120 of the user. The request can be communicated to the payment server via the Internet 140.

The payment server 130 can access the user account 133, as shown in step 302. The user account can be stored in the memory 132 of the server 130. The payment server 130 can determine, from information in the user account 133, whether or not the user is authorized to have the token issue for the specified money amount, as shown in step 303. For example, the payment server 130 can determine if the user has sufficient funds in the user account 133 to cover the money amount of the token or if issuing the token for the specified money amount will cause the user to exceed a predetermined credit limit.

The payment server 130 can cause the token to be generated if the user is authorized to have the token issue for the specified money amount, as shown in step 304. The token can be generated by the payment server 130, a dedicated token server, or any other device. The payment server can then issue the token, as shown in step 305.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

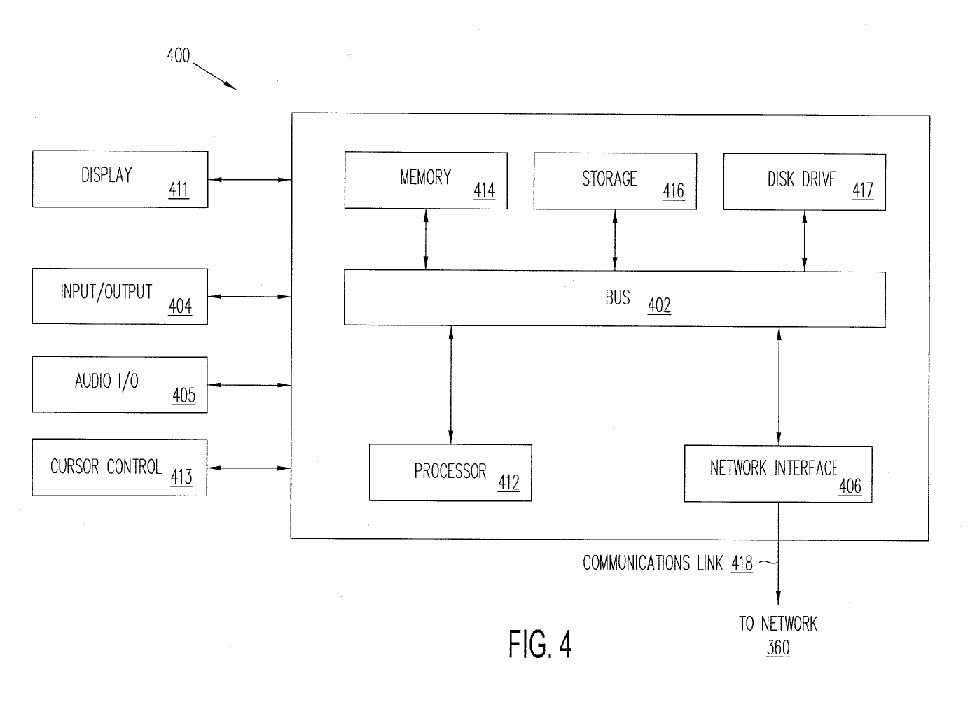

FIG. 4 is a block diagram of a computer system 400 suitable for implementing one or more embodiments of the present disclosure. In various implementations, the PIN pad and/or merchant terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many fauns, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another.

Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

According to an embodiment, the token can be encrypted. The token can be encrypted using any cryptographic algorithm, such as AES 256 for example. A software or hardware token can be encrypted by the payment server 130 and can be decrypted by the user mobile device 120, the recipient mobile device 150, and/or the merchant device 110. The payment server 130 or an administrator can determine the strength of the encryption, such as prior to or during token generation. Increasing the strength of the encryption can result in increased token size. Increasing the strength of the encryption can be accomplished by changing the encryption algorithm and/or by increasing a length of a key.

A user can monitor all or any desired portion of the token generation, token issuing, and token use processes. For example, the user can be notified when the token is used. Such notification can include the date and time of the purchase transaction, the name of the recipient, the identification of the merchant, the identification of the product or products purchased, and the cost of the product or products purchased.

According to an embodiment, the user can specify that the token can only be used in the combination with a mobile number (such as a cellular telephone number, mobile device serial number, or medium access controller (MAC) ID) of the user or any other person. Thus, the token can include the mobile number or information representative thereof, e.g., a hash. Both the mobile number and the token can thus be required for the recipient to purchase a product.

According to an embodiment, the mobile number can function as a user name and/or the token can function as a PIN or visa versa. The user or an administrator can restrict the number of wrong token use attempts that are allowed against the user's mobile number. Once an actual number of wrong attempts exceeds a predefined number, then all the tokens associated with the user account 134 can be suspended or temporarily locked for security purposes. The user can receive notification of the malicious attempts to use the token or any malicious attempts to unlock or regenerate a token.

According to an embodiment, the payment server 130 can send the information regarding the token to the user and/or the recipient via telephone, text messaging, email, any other method or any combination of methods. For example, one half of the token can be communicated to the user and/or recipient via email and another half of the token can be communicated to the user and/or recipient via text messaging, e.g., SMS. In this manner, security can be enhanced such that a malicious person is likely to be limited to access to one half of the token, such as when the malicious person hacks the recipient's email account.

According to an embodiment, the payment server 130 can automatically create an account for the recipient. For example, after the recipient completes a purchase transaction using a token, the payment server 130 can create an new account for the recipient using any available recipient information (such as information that was provided by the recipient during the purchase, e.g., a shipping address, email address, mobile number, etc.). The recipient can provide such information when making an online purchase, for example.

After the recipient receives the token, the payment server 130 can communicate with the recipient via email, text messaging, or any other means and payment server 130 can provide an opportunity for the recipient to quickly and easily create a payment provider account. The payment server 130 can further offer an incentive to the recipient for the recipient to immediately create an account. For example, the payment server 130 can offer to credit the amount of the purchase (or some portions thereof) to the newly created account or can offer to link the token to newly created account. The purchase can count toward any points program for the new account that is offered by the payment provider.

The recipient can be given the ability to check the remaining balance amount of the token securely. For example, the recipient can be allowed to provide the token to the payment server 130 and the payment server 130 can provide the remaining balance. This can be done via email, text messaging, voice, or any other method. The recipient can be required to provide an email ID, mobile number, or other identification to the payment server 130 for security purposes. The email ID, mobile number, or other identification can have been provided to the payment server 130 by the user during or prior to the token generation process. The email ID, mobile number, or other identification can have been provided to the payment server 130 by the recipient during a setup process or at any other time.

The user, the recipient, an administrator, or any other specified person can have the ability to revoke the token. Revoking the token can be immediate, e.g., can take place as soon as the revocation is communicated to the payment server 130. Thus, the token can be revoked quickly if it is compromised, lost, or stolen.

As used herein, the term “store” can include any business or place of business. The store can be a brick and mortar store or an online store. The store can be any person or entity that sells a product.

As used herein, the term “product” can include any item or service. A product can be anything that can be sold.

As used herein, the term “merchant” can include any seller of products. The term merchant can include a store. The products can be sold from a store or in any other manner.

As used herein, the term “mobile device” can include any portable electronic device that can facilitate data communications, such as via a cellular network and/or the Internet. Examples of mobile devices include cellular telephones, smart phones, tablet computers, and laptop computers.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system comprising:
a memory of a payment provider storing account information of a user in a user account, the account information including a name of a recipient of a token and a money amount for the token, wherein the token was given by the user to the recipient and wherein the recipient does not have an account with the payment provider;
one or more processors of the payment provider operable to:
receive a communication including a request that the token be used by a person to make a purchase for a specified money amount;
access the user account;
determine from the user account if person is the recipient and if the specified money amount is less than or equal to the money amount of the token; and
authorize the purchase if the person is the recipient and if the specified money amount is less than or equal to the money amount of the token.

2. The system of claim 1, wherein the one or more processors are operable to create an account for the recipient without requiring the recipient to participant in creation of the account.

3. The system of claim 1, wherein the one or more processors are operable to:
request permission from the recipient to create an account for the recipient; and
create an account for the recipient without requiring further participation from the recipient if the permission is granted.

4. The system of claim 1, wherein the one or more processors are operable to create an account for the recipient using information regarding the recipient that was obtained from one or more purchase transactions made by the recipient using the token.

5. The system of claim 1, wherein the one or more processors are operable to receive a communication from the recipient including a mobile number of the recipient to facilitate authorization of the purchase.

6. The system of claim 1, wherein:
the account information includes a mobile number of the recipient;
the one or more processors are operable to:
receive a communication that includes a number entered by the recipient via a merchant device;
compare the communicated number to the mobile number; and
authorize the purchase if the communicated number is the same as the mobile number.

7. The system of claim 1, wherein:
the one or more processors are operable to:
receive a communication including a request that the token be issued for a specified money amount;
access the user account;
determine from the user account if the user is authorized to have the token issue for the specified money amount;
generate the token if the user is authorized to have the token issue for the specified money amount; and
send information regarding the token to the user.

8. A method comprising:
storing, in a memory of a payment provider, account information of a user in a user account, the account information including a name of a recipient of a token and a money amount for the token, wherein the token was given by the user to the recipient and wherein the recipient does not have an account with the payment provider;
receiving, via one or more processors, a communication including a request that the token be used by a person to make a purchase for a specified money amount;
accessing, via the one or more processors, the user account;
determining, via the one or more processors, from the user account if person is the recipient and if the specified money amount is less than or equal to the money amount of the token; and
authorizing, via the one or more processors, the purchase if the person is the recipient and if the specified money amount is less than or equal to the money amount of the token.

9. The method of claim 8, further comprising creating, via the one or more processors, an account for the recipient without requiring the recipient to participant in creation of the account.

10. The method of claim 8, further comprising:
requesting, via the one or more processors, permission from the recipient to create an account for the recipient; and
creating, via the one or more processors, an account for the recipient without requiring further participation from the recipient if the permission is granted.

11. The method of claim 8, further comprising creating, via the one or more processors, an account for the recipient using information regarding the recipient that was obtained from one or more purchase transactions made by the recipient using the token.

12. The method of claim 8, further comprising receiving, via the one or more processors, a communication from the recipient including a mobile number of the recipient to facilitate authorization of the purchase.

13. The method of claim 8, wherein:
the account information includes a mobile number of the recipient; and
further comprising:
receiving, via the one or more processors, a communication that includes a number entered by the recipient via a merchant device;
comparing, via the one or more processors, the communicated number to the mobile number; and
authorizing, via the one or more processors, the purchase if the communicated number is the same as the mobile number.

14. The method of claim 8, further comprising:
receiving, via the one or more processors, a communication including a request that the token be issued for a specified money amount;
accessing, via the one or more processors, the user account;
determining, via the one or more processors, from the user account if the user is authorized to have the token issue for the specified money amount;
generating, via the one or more processors, the token if the user is authorized to have the token issue for the specified money amount; and
sending, via the one or more processors, information regarding the token to the user.

15. A computer program product comprising a non-transitory computer readable medium having computer readable and executable code for instructing one or more processors to perform a method, the method comprising:
storing, in a memory of a payment provider, account information of a user in a user account, the account information including a name of a recipient of a token and a money amount for the token, wherein the token was given by the user to the recipient and wherein the recipient does not have an account with the payment provider;
receiving, via one or more processors, a communication including a request that the token be used by a person to make a purchase for a specified money amount;
accessing, via one or more processors, the user account;
determining, via one or more processors, from the user account if person is the recipient and if the specified money amount is less than or equal to the money amount of the token; and
authorizing, via one or more processors, the purchase if the person is the recipient and if the specified money amount is less than or equal to the money amount of the token.

16. The computer program product of claim 15, further comprising creating, via the one or more processors, an account for the recipient without requiring the recipient to participant in creation of the account.

17. The computer program product of claim 15, further comprising:
requesting, via the one or more processors, permission from the recipient to create an account for the recipient; and
creating, via the one or more processors, an account for the recipient without requiring further participation from the recipient if the permission is granted.

18. The computer program product of claim 15, further comprising creating, via the one or more processors, an account for the recipient using information regarding the recipient that was obtained from one or more purchase transactions made by the recipient using the token.

19. The computer program product of claim 15, further comprising receiving, via the one or more processors, a communication from the recipient including a mobile number of the recipient to facilitate authorization of the purchase.

20. The computer program product of claim 15, wherein:
the account information includes a mobile number of the recipient; and
further comprising:
receiving, via the one or more processors, a communication that includes a number entered by the recipient via a merchant device;
comparing, via the one or more processors, the communicated number to the mobile number; and
authorizing, via the one or more processors, the purchase if the communicated number is the same as the mobile number.

21. The computer program product of claim 15, further comprising:
receiving, via the one or more processors, a communication including a request that the token be issued for a specified money amount;
accessing, via the one or more processors, the user account;
determining, via the one or more processors, from the user account if the user is authorized to have the token issue for the specified money amount;
generating, via the one or more processors, the token if the user is authorized to have the token issue for the specified money amount; and
sending, via the one or more processors, information regarding the token to the user.
